(19) United States
(12) Patent Application Publication
(10) Pub. No.: US 2025/0251024 A1
(43) Pub. Date: Aug. 7, 2025

(54) ELECTROMAGNETIC ACTUATION DEVICE AND BRAKING OR CLAMPING DEVICE USING THE SAME

(71) Applicant: SITEMA GmbH & Co. KG, Karlsruhe (DE)

(72) Inventor: Thomas Haase, Steinweiler (DE)

(73) Assignee: SITEMA GmbH & Co. KG, Karlsruhe (DE)

(21) Appl. No.: 19/046,668

(22) Filed: Feb. 6, 2025

(30) Foreign Application Priority Data
Feb. 6, 2024 (DE) 102024103332.0

(51) Int. Cl. F16D 59/02; F16D 65/00; F16D 65/28; F16D 121/14; F16D 121/22; F16D 123/00

(52) U.S. Cl. CPC F16D 59/02; F16D 65/0006; F16D 65/28; F16D 2121/14; F16D 2121/22; F16D 2123/00

(57) ABSTRACT

An electromagnetic actuation device for a braking or clamping device is provided, having a stator with an energizable magnetic coil, an armature movable relative to the stator, and a spring operatively connected to the armature such that, when the magnetic coil is de-energized, an air gap with a first width is formed between the armature and stator. The spring has a first pretension, and, when the magnetic coil is energized, the air gap width is reduced relative to the first width, and has a second pretension, greater than the first pretension. An actuation element is in operative communication with the armature and actuates the braking or clamping device subject to an armature position. A shock-absorbing element having a speed-dependent damping force characteristic is arranged between the armature and stator; or on a side of the armature remote from the stator, between the armature and a bearing/housing part; or both locations.

### CROSS-REFERENCE TO RELATED APPLICATIONS

This application claims priority from German Patent Application No. 10 2024 103 332.0, filed Feb. 6, 2024, which is incorporated herein by reference as if fully set forth.

### TECHNICAL FIELD

The invention relates to an electromagnetic actuation device for a braking or clamping device.

The invention also relates to an electromagnetically actuated braking or clamping device, which comprises the electromagnetic actuation device according to the invention.

### BACKGROUND

Over the last 40 years, clamping devices or clamping units having hydraulic or pneumatic actuators or actuation devices have proven effective in safety-relevant applications (e.g. fall protection) and have been successful in receiving international certification (DIN ISO 13948) from the BG/DGUC or TÜV

They are preferably used in systems in which the movement of an object relative to a rod, or a similarly elongated body, is to be prevented or braked by the clamping thereof, for which a so-called clamping cage is regularly used, which acts on the rod in a clamping manner from all sides. The term “clamping cage” is used without restriction below to represent any type of braking or clamping element. Also, no strict distinction is made between clamping units and braking units (or brakes), since clamping may ultimately also lead to braking (up to zero speed).

Such already-known systems are mechanically pretensioned by hydraulic or pneumatic pressure, wherein the corresponding potential energy is stored in a spring element, e.g. a compressed disk spring assembly. If an emergency is identified, the pretensioning pressure (hydraulic, pneumatic) drops, and the disk spring assembly transfers its potential energy into the clamping mechanism, i.e. to the clamping cage. This internal pressure drop in the internal pressure chamber takes place via valves and openings in the housing. However, at the moment when the pressure supply is switched off, the inner pressure chamber (of the braking or clamping unit) is still “loaded” with pressure, which pressure has to firstly be released over a certain period of time via the said openings and/or special (rapid) vent valves. During this time, the internal (continuously released) pressure opposes the spring element as a (spring) force and hampers the movement/acceleration of the activated clamping cage. The speed of the activated clamping cage is thus automatically reduced subject to corresponding properties of the valves, openings, bores and mechanical time constants.

Electric clamping units based on electromagnets do not possess such a “preloaded” pressure chamber, which means that the force of the spring assembly when the electromagnet is switched off is converted almost abruptly into an acceleration of the clamping cage and the clamping cage is maximally accelerated, whereby the reaction time of the brake is minimal. Consequently, although—in a positive respect—the quickest reaction times are produced, there is also a high level of wear on the guide elements and strong impact-shock impulses during both the opening and closing of the actuator or actuator mechanism (i.e. the electromagnetic actuation device), which may result in a greatly reduced service life. This reduced service life makes economical use of electric clamping systems according to the prior art difficult (or even impossible).

An electromagnetic actuation device of the type in question is known from the prior art, in particular from EP 2 756 505 B1. This may be seen as disadvantageous in that, as already explained, unlike with hydraulic or pneumatic actuation devices, the potential energy stored in the spring element is provided abruptly for braking or clamping purposes, which results in the said problems relating to the service life.

Specifically, in EP 2 756 505 B1, the use of electric actuators (in particular in the form of solenoid actuators) in electric clamping systems is described, wherein explicit reference is made to the addressed (mechanical) pretension resulting from spring assemblies. However, the said service-life problems are not addressed, which means that the subject matter described in the said printed document can only be transferred to clamping systems at the expense of a relatively short service life. Specifically, the shock load when closing the actuator mechanism (i.e. when releasing the brake or opening the clamping system), which is caused by the armature and the stator colliding, places huge demands on the system integrator due to the high load on surrounding components.

As a possible solution to the said problems, EP 2 504 606 B1 proposes using a fluid (and associated valves) for damping purposes. The printed document discloses a bistable, magnetic shock-absorber arrangement having an integrated piston and openings contained therein so that the fluid may flow back and forth between two chambers in a damped manner. The disadvantage with this is the additional design effort, the necessary installation space, the enclosed fluid medium and the associated (inherent) service-life problems, e.g. leak-tightness.

CN 212004065 U discloses a damping device having mutually repelling magnets or magnetic forces. In this, the counter- or restoring forces which are naturally present in such arrangements can be seen as disadvantageous. Such counter-forces should be avoided, since they counteract the force of the spring element and thereby reduce the available clamping force of the clamping cage.

### SUMMARY

The invention is based on the object of reproducing the speed-restricting effect (known from hydraulic/pneumatic systems) through an internal pressure drop in order to extend the service life of electric clamping or braking units or the corresponding electromagnetic devices for a braking or clamping device, without being confronted by other problems, for example relating to increased installation space, leak-tightness or disruptive counter-forces.

The said electromagnetic actuation devices are alternatively also referred to as “actuators” or “actuator mechanisms” in the present description.

This object is achieved according to the invention by an electromagnetic actuation device for a braking or clamping device having one or more of the features disclosed herein and by an electromagnetically actuated braking or clamping device having one or more of the features disclosed herein, which comprises an electromagnetic actuation device according to the invention.

Advantageous developments of the idea according to the invention are defined in the description and claims that follow.

According to the invention, an electromagnetic actuation device for a braking or clamping device comprises a stator having an energizable magnetic coil, an armature, which is movable relative to the stator, and a spring element, which is designed and arranged and mechanically operatively connected to the armature in such a way that, when the magnetic coil is de-energized, an air gap having a first width is formed between the armature and stator, the spring element having a first pretension, and when the magnetic coil is energized, a width of the air gap between the armature and stator is reduced relative to the first width, preferably to a minimal width, most preferably to a width of zero, the spring element having a second pretension, which is greater than the first pretension. Furthermore, the electromagnetic actuation device comprises an actuation element, which is in operative communication with the armature and is designed to actuate the braking or clamping device subject to a position of the armature. The electromagnetic actuation device is characterized by at least one shock-absorbing element having a speed-dependent damping force characteristic, which is arranged either a) between the armature and stator, or b) on a side of the armature which is remote from the stator, between the armature and a bearing/housing part, or c) according to variant a) and variant b), i.e. at least two shock-absorbing elements are present in variant c).

As a result of the shock-absorbing element, purely speed-dependent damping is integrated in the actuator, i.e. in the electromagnetic actuation device: the shock-absorbing element is therefore designed such that damping does not take place if there is no movement or speed (of the armature), in which case no (or only minimal) restoring forces moreover occur. The associated material damping curve of a material which is or can be used for the shock-absorbing element is explained more precisely below with reference to FIG. 3.

The invention therefore distinguishes itself from devices having elastic damping elements (such as springs or magnets) which, although they apply counter-forces and may reduce accelerations or speeds, also generate counter-forces in the static case (i.e. v=0) due to their mode of operation, which counter-forces disadvantageously oppose the force of the spring element and thereby reduce the usable clamping force of the clamping cage. In contrast, the shock-absorbing element used in the present case has no (or only negligible) internal restoring forces.

It is irrelevant here whether the damping curve of the shock-absorbing element is linear or non-linear. The curve progression of the damping “only” influences the end speed of the armature, which represents an important, but subordinate, design parameter.

The shock-absorbing element may be designed in the manner of a shock-absorbing plate, which means that a material thickness of the shock-absorbing element relative to the surface dimensions (width, length) is relatively small. The form of the shock-absorbing element can be described particularly well by the so-called form factor, which is given as a quotient of the loaded surface and the lateral surface. Plates can therefore be well described by a form factor>=3.

The terms “shock-absorbing plate” and “shock-absorbing element” are used synonymously below.

In a first configuration of the invention, the integration of a shock-absorbing plate may be realized between the armature and stator, see variant a) above. In this, the shock-absorbing plate generates a purely speed-dependent counter-force, opposing the magnetic force, during the closing of the actuator (i.e. when the brake or clamping mechanism is released or opened), which counter-force for v=0 is (practically) zero. This speed-dependent counter-force limits the maximal speed of the armature according to Newton's Law during the closing of the actuator (as soon as the spring force and counter-force are removed) and therefore reduces the impact speed of the armature against the stator. Consequences of this are an immediate reduction in the force exerted on the stator by the armature during the impact, a reduction in the noise emissions and a reduction in the shock load (and therefore also a reduction in the material wear caused by impact).

Through the addition of a spacer film on the armature (or the stator), with which the minimal achievable spacing between the armature and stator is restricted to a thickness of the spacer film, it is optionally possible to achieve the inclusion of a defined air gap with a minimal width of greater than zero between the two said components. This air gap accelerates the separation of the armature from the stator during the application of the brake due to an additional magnetic resistance and thus ensures an optimized reaction time of the clamping or braking unit.

In another configuration of the invention, the integration of a shock-absorbing plate may (also) be realized behind the moved armature, see variant b) above. In this case, the shock-absorbing plate generates a speed-dependent counter-force to the spring force during the opening of the actuator, i.e. during the application of the brake. This speed-dependent counter-force in turn limits the maximum speed of the armature according to Newton's Law.

As already described, both variants a) and b) may be combined in order to exploit the respective advantages together, c.f. variant c).

The configuration and calculation of the shock-absorbing element, in particular in terms of its dimensions, and especially the thickness, takes place on the basis of the available installation space, the material properties of the material used, especially the damping properties and the drive configuration, i.e. the force-travel characteristic, which is extremely non-linear in the case of solenoid actuators. By way of example, in a preferred configuration, the (ring-shaped) shock-absorbing elements have the following dimensions: Internal diameter approximately 55 mm, external diameter approximately 75 mm. The external diameter of the solenoid actuator is approximately 125 mm here.

In yet another configuration of the invention, on a side remote from the actuator, the shock-absorbing plate may be supported on a housing or housing part connected to the stator, in order to absorb the counter-forces. This has proven to be particularly expedient and structurally easy to implement.

Tests carried out by the applicant have revealed that, in particular, shock-absorbing plates made of viscoelastic PUR material are especially suitable for absorbing shock-like loads in an advantageous manner within the context of the invention.

By way of example, a mixed cellular polyurethane (PUR) elastomer, which preferably has the following performance data, may be used as the material for the shock-absorbing plates:

Performance data

| | Measurement | | |
|---|---|---|---|
| Material properties | unit | | Test procedure |
| Compressive strength | (N/mm²²) | 0.03-0.30 | EN ISO 844² |
| (at 10% deformation) | | | |
| Static application | (N/mm²²) | 0.010-0.150 | |
| Mechanical loss factor | | 0.45-0.50 | DIN 53513² |
| Rebound resilience | (%) | 10-15 | EN ISO 8307 |
| Compression set³ | (%) | <5 | EN ISO 1856 |
| Min. breaking stress, | (N/mm²) | 0.4-1.5 | DIN EN ISO |
| tension | | | 527-3/5/100 |
| Min. elongation at | (%) | 125-175 | DIN EN ISO |
| break, tension | | | 527-3/5/100 |
| Operating | (° C.) | −5° C. to | |
| temperature4 | | +50° C. | |

Within the context of the invention, a reduced or adjustable speed of the armature is achieved during the opening and closing of the drive (i.e. during the switching on and off of the power supply to the coil). There are no restoring forces (or only very minimal restoring forces) in the actuator mechanism in the static state (v=0) since the counter-force of the damping plates is speed-dependent, which means that counter-forces only exist during the movement. Moreover, there is consequently no (are almost no) additional thermal load on the solenoid actuator. All in all, this results in a long service life of correspondingly equipped clamping units due to the reduced wear, in particular on guide elements.

In the double-sided embodiment (variant c)), the shock load is greatly reduced due to the damped impact of the armature against the stator on the one hand and of the armature against the bearing or housing parts on the other. The restriction of the speed during the opening procedure and during the closing procedure moreover results in a greatly reduced shock load in the connected (customer) system (e.g. a press) and also reduced noise emissions (impact noises).

Integration (retrofittability) in existing actuators/systems is possible in a simple and cost-effective manner.

The above-mentioned adjustability in terms of the options for speed control and adaptation may be realized both via the size of an effective active surface of the shock-absorbing element (with the same material) or via the choice of material properties (softer, harder, with the same active surface). Alternatively or additionally, the dimensioning of the motor may also be adapted (choice of magnetic material, number of coil windings, strength of the coil current, dimensioning of the armature and/or the stator, . . . ).

Simple replaceability is realized in the case of servicing.

From the point of view of the applicant, the following configurations of the actuation device according to the invention have proven particularly advantageous:

In an advantageous development of the electromagnetic actuation device for a braking or clamping device, the spring element is arranged between the armature and the stator or between the armature and a first bearing/housing part connected to the stator. In the second case, the armature preferably extends through the stator by means of an armature extension and is designed to act directly or indirectly on the spring element by means of the armature extension.

Therefore, the spring element does not necessarily have to be arranged on the same side, specifically of the stator, which means that numerous advantageous designs can be realized.

In another advantageous development of the electromagnetic actuation device for a braking or clamping device, the shock-absorbing element is made from a material which, in the case of a mechanical action having an increasing active speed, generates an increasing counter-force opposing the action, wherein the counter-force at a speed of zero is preferably likewise substantially zero.

Reference has already been made to this above. In this way, the counter-force compensates the spring force gradually and thus ensures a restriction of the speed, although the actuation device advantageously still “starts” immediately. In the open (idle) state, however, there is (practically) no counter-force which might lessen the available spring force.

In a further advantageous development of the electromagnetic actuation device for a braking and/or clamping device, the shock-absorbing element is made from a viscoelastic plastic material, preferably from a viscoelastic plastic foam.

Tests carried out by the applicant have shown that the intended effect can thus be optimized.

In a further advantageous development of the electromagnetic actuation device for a braking or clamping device, the shock-absorbing element is made from a polyurethane material.

This material has proven particularly suitable for cost reasons and also due to its material properties or durability.

In a particularly advantageous development of the electromagnetic actuation device for a braking or clamping device according to variant c), the shock-absorbing element is made from the same material or materials with the same damping properties on both sides of the armature.

However, according to variant c), it is alternatively within the scope of the invention for the shock-absorbing element to be made from different materials or materials with different damping properties on both sides of the armature.

In this way, the damping properties can be chosen and adapted according to desired characteristics.

In yet another advantageous development of the electromagnetic actuation device for a braking and clamping device, according to variant a), a spacer film with a film thickness is arranged between the armature and stator, in a region separated from the shock-absorbing element, the said minimal width being defined by the film thickness.

Reference has already been made above to the particular advantages that can be achieved by such a configuration.

By way of examplewithout being restricted thereto—the following film materials are used:

An adhesive tape laminated with a polyester/polyester nonwoven material with acrylate adhesive, conforming to RoHS directive 2011/65/EU, which is designed to be adhesive on one side and preferably has the following properties:

| | | Polyester/polyester |
|---|---|---|
| Substrate | | nonwoven material |
| Substrate thickness | mm | 0.160 |
| Adhesive type | | Acrylate |
| Total thickness | mm | 0.215 |
| Tensile strength | N/cm | 45 |
| Elongation at break | % | 20 |
| Adhesiveness/Peel | N/cm | 60 |
| adhesion strength | | |
| Breakdown voltage | kV | 5 |

In an advantageous development of this idea, the spacer film is applied, e.g. bonded, to the armature or to the stator.

In this way, the said configuration can be realized or retrofitted particularly easily and effortlessly.

In yet another advantageous development of the electromagnetic actuation device for a braking or clamping device, at least the armature and the stator are designed to be rotationally symmetrical and each have a central opening through which a rod, or similar object, to be braked or clamped can be or is guided. The shock-absorbing element is therefore preferably of ring-shaped design and is arranged concentrically to the openings.

This corresponds to a prevailing design of known actuation devices for a braking or clamping device or to the braking or clamping devices themselves, so that, in particular, replaceability or retrofitting of existing devices is enabled.

In yet another advantageous development of the electromagnetic actuation device for a braking or clamping device according to variant a), the spacer film is of ring-shaped design and is arranged concentrically around the shock-absorbing element and/or concentrically to the openings, radially within the shock-absorbing element.

The applicant has hereby achieved the best results in practice. Moreover, the damping effect is designed to be as homogeneous as possible, and the installation space available for the damping means is used as effectively as possible.

In another, likewise advantageous development of the electromagnetic actuation device for a braking or clamping device according to variant a) or c), the armature or the stator has a holding structure for the shock-absorbing element, preferably a ring-shaped holding structure.

In this way, it is ensured that the shock-absorbing element remains permanently located at its intended site in order to further increase the service life.

In yet another, likewise advantageous development of the electromagnetic actuation device for a braking or clamping device according to variant b), the bearing/housing part has a holding structure for the shock-absorbing element, preferably a ring-shaped holding structure. Most preferably, the bearing/housing part is designed to be rotationally symmetrical here and has a central opening through which a rod, or the like, to be braked or clamped can be or is guided.

In this way, the advantages mentioned above for variant a) can also be exploited within the context of variant b) or variant c).

It has already been pointed out that, in one configuration of the invention, the shock-absorbing element, depending on requirements, may have a linear or non-linear damping force characteristic subject to the speed.

### BRIEF DESCRIPTION OF THE DRAWINGS

Further properties and advantages of the invention can be found in the description below of exemplary embodiments, with reference to the drawing.

FIG. 1 shows an electromagnetic actuation device for a braking or clamping device according to the prior art in a first state;

FIG. 2 shows an electromagnetic actuation device for a braking or clamping device according to the prior art in a second state;

FIG. 3 shows two exemplary associations between speed and counter-force in a shock-absorbing material used within the context of the invention;

FIG. 4 shows an electromagnetic actuation device according to the invention for a braking or clamping device in a first state;

FIG. 5 shows an electromagnetic actuation device according to the invention for a braking or clamping device in a second state;

FIG. 6 shows another electromagnetic actuation device according to the invention for a braking or clamping device in a first state;

FIG. 7 shows another electromagnetic actuation device according to the invention for a braking or clamping device in a second state; and

FIG. 8 shows a braking or clamping device according to the invention.

### DETAILED DESCRIPTION

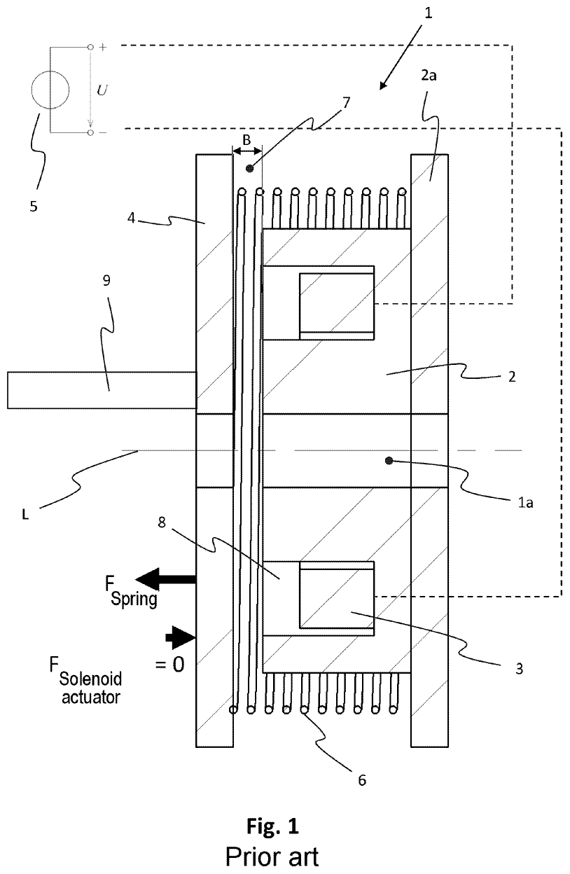

FIG. 1 shows an electromagnetic actuation device for a braking or clamping device, as is known from the prior art. However, the basic design also applies to the present invention; the essential differences will be discussed in more detail below.

The electromagnetic actuation device 1, which may be provided especially for a braking or clamping device, comprises a stator 2 having an energizable magnetic coil 3 and an armature 4, which is movable relative to the stator. The stator 2, magnetic coil 3 and armature 4 together form so-called solenoid actuator. A voltage source 5 is provided for the power supply to the magnetic coil 3. A spring element 6 is arranged between the armature 4 and a bearing or housing part 2a (also referred to as first bearing or housing part here) connected to the stator 2. The overall arrangement is designed to be rotationally symmetrical with respect to the axis L and has an axially parallel, central opening 1a, at least in the stator 2, the bearing/housing part 2a, the magnetic coil 3 and the armature 4.

The spring element 6 (a helical spring here, without being restricted thereto) is designed and arranged and mechanically operatively connected to the armature 4 in such a way that, when the magnetic coil is de-energized—as shown in FIG. 1—in a first state of the actuation device 1, an air gap 7 having a first width B is formed between the armature 4 and stator 2. In this state, the spring element 6 has a first pretension and generates a corresponding spring force F_{spring}, while the magnetic force between the stator 2 and armature 4 is equal to zero (F_{solenoid actuator}=0). The spring element 6 therefore presses the stator and the actuator 4 apart. To this end, the armature 4 is guided axially within the arrangement, e.g. by a rod (not shown in FIG. 1) guided into the opening 1a or through this opening.

Reference sign 8 denotes a potting compound for sealing a coil chamber within the stator 2.

Reference sign 9 denotes an actuation element, which is in operative communication with the armature 4 and is designed to actuate the said braking or clamping device (not shown in FIG. 1) subject to a position of the armature 4. The actuation element 9 is only illustrated very schematically in FIG. 1; in a departure from this arrangement, it may also extend through the stator 2 and therefore be active on the rear side thereof, which is remote from the armature 4. In other words: the armature 4 may extend through the stator 2 by means of an armature extension (not shown here) and, in particular, it may also be designed to act directly or indirectly on the then correspondingly arranged spring element 6 by means of the armature extension.

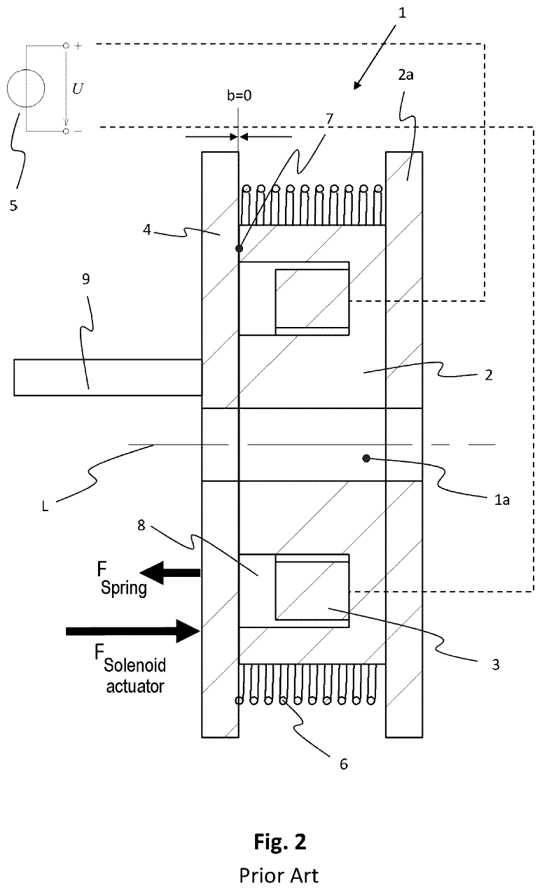

If the magnetic coil 3 is energized—as shown in FIG. 2-a width of the air gap 7 between the armature 4 and stator 2 is reduced relative to the first width B to a dimension b, preferably to a minimal width, most preferably to a width of zero, as in FIG. 2, due to the magnetic attraction between the armature 4 and stator 2, the spring element 6, which is compressed relative to the illustration in FIG. 1, having a second pretension in the corresponding second state, which is greater than the first pretension. However, the magnitude of the corresponding spring force F_{spring} is smaller than the magnetic force F_{solenoid actuator} between the stator 2 and armature 4. The actuation element 9 has therefore also been displaced relative to its position in FIG. 1, whereby an actuation of the said braking or clamping device may be brought about.

The configuration shown is disadvantageous in that, according to FIG. 2, the armature 4 impacts against the stator 2 at a relatively high speed, which, amongst other things, leads to wear and causes noise.

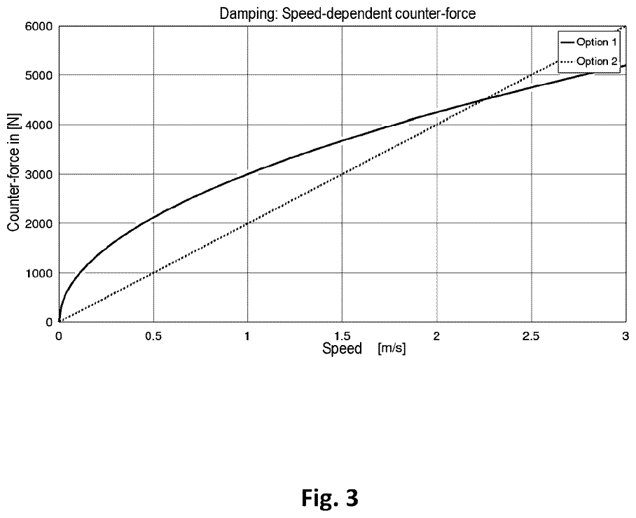

The present invention now goes beyond the prior art in that, in the actuation device 1 of the above-described type, at least one shock-absorbing element, as explained in more detail below, is provided in order to lessen the impact of the armature 4 against the stator 2. The shock-absorbing element is made from a material which demonstrates a speed-dependent damping behavior in the form of a damping counter-force, as illustrated schematically in FIG. 3. The speed here refers to the speed of an object which strikes the shock-absorbing element, e.g. the armature 4 (c.f. FIG. 2) in the present case. According to option 1, the counter-force here may be subject to the speed in a non-linear manner or, according to option 2, it may have a linear association with the speed. Both options may be applied within the context of the invention. Other associations are also possible and can be used within the context of the invention.

Of significance here is that the counter-force when there is no speed (v=0) is likewise zero, i.e. a counter-force is not generated without movement.

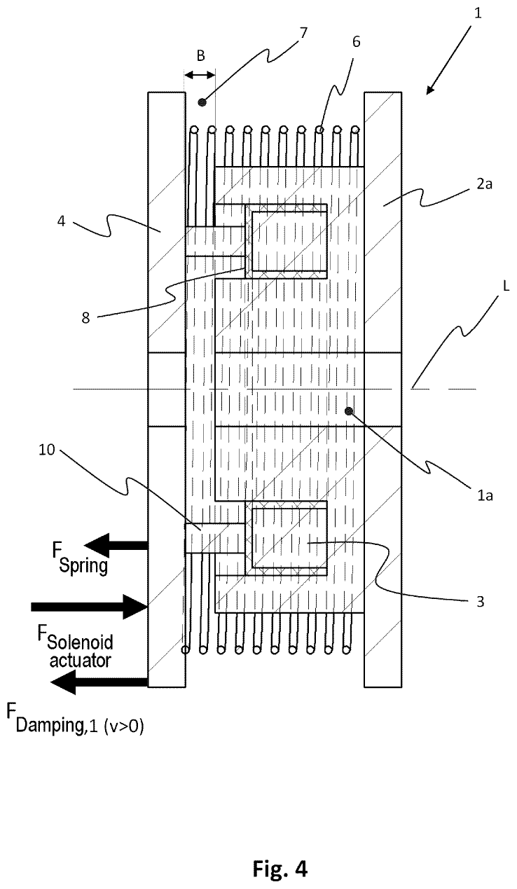

FIG. 4 shows a configuration of the actuation device 1 which is further developed over the prior art and in which a ring-shaped shock-absorbing element 10 with a speed-dependent damping-force characteristic, as just described, is present, which shock-absorbing element is arranged between the armature 4 and stator 2 or, more precisely, between the armature 4 and the potting compound 8 (of the magnetic coil 3). This corresponds to a variant a) of the invention. In the chosen sectional illustration, the shock-absorbing element 10 is of circular ring-shaped design, albeit without the invention being restricted thereto.

Otherwise, the actuation device 9 is designed as in FIGS. 1 and 2. The actuation element 9 is not illustrated; it may essentially be designed as outlined further above. Further illustration of the voltage source has been omitted.

During the closure of the solenoid actuator, i.e. when the magnetic coil 3 is energized (the power source is not illustrated, c.f. FIG. 2), the following forces act on the armature 4 according to FIG. 4, s denoting the travel and s the speed:

$${F}_{armature} ( s , \dot{s} ) = {F}_{solenoid actuator} ( s ) - {F}_{spring} ( s ) - {F}_{damping , 1} ( \dot{s} ) .$$

The speed-dependent damping force F_{damping,1} (\dot{s}) due to the shock-absorbing element 10 ensures that the impact speed is restricted. It is (approximately) zero so long as the armature is not moving (\dot{s}=°v=0).

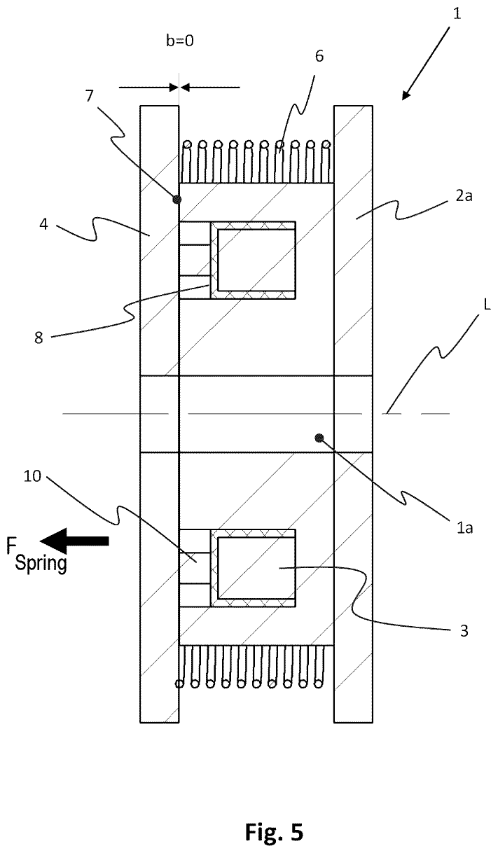

In FIG. 5, the closed state of the actuation device 1 of FIG. 4 is shown (magnetic coil 3 is energized). During the subsequent opening of the solenoid actuator (i.e. when the power supply to the magnetic coil 3 is switched off), the following applies for the active forces:

$${F}_{armature} ( s ) = - {F}_{spring} ( s ) .$$

The solenoid actuator (comprising the armature 4, magnetic coil 3 and stator 2) is without power, the shock-absorbing element 10 does not generate any force, since v=0, and moreover has (practically) no internal restoring forces, as there would be for a spring, for instance.

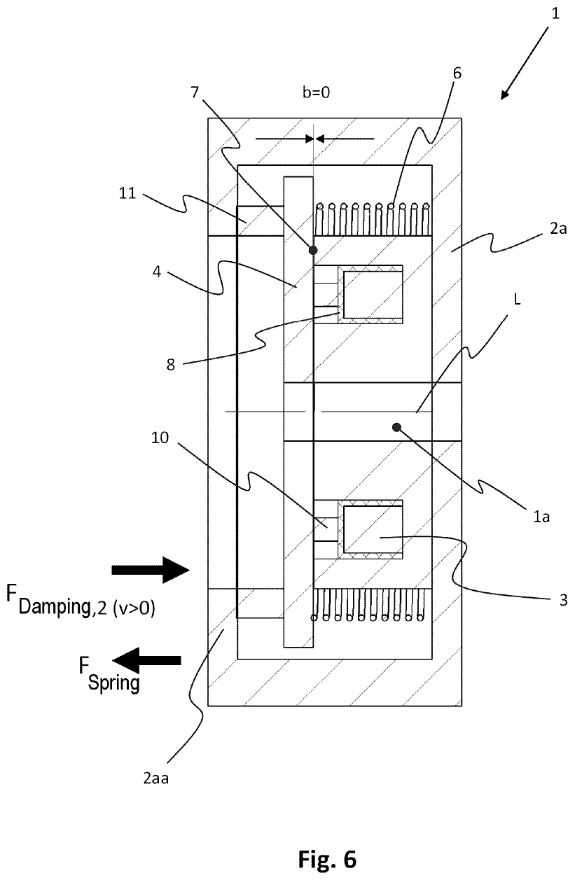

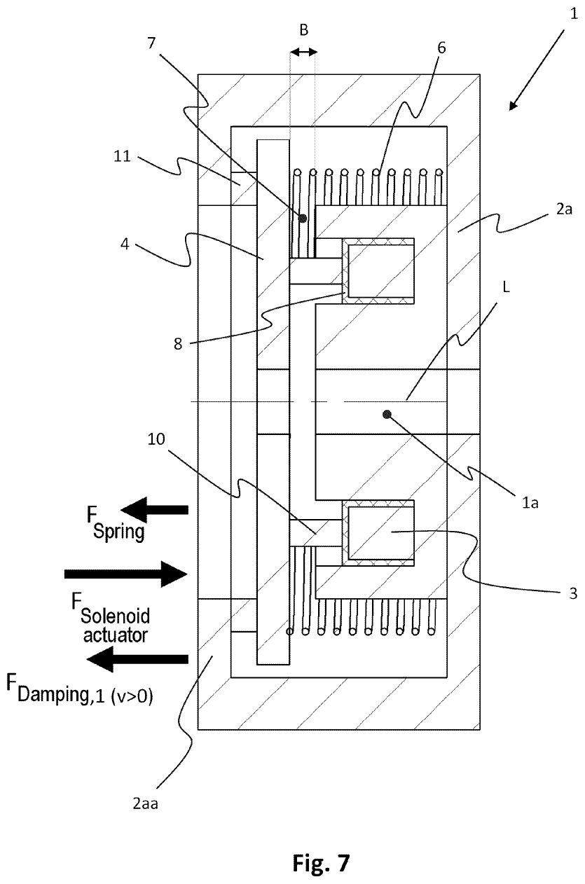

A slightly modified configuration of the actuation device according to the invention is shown in FIGS. 6 and 7 (in turn without a voltage source and actuation element).

In the modified configuration, the bearing/housing part 2a extends further along the axis L and reaches beyond the armature by means of a terminal radial projection 2aa. Between an inner side (facing the armature 4) of the projection 2aa and the armature 4, a further shock-absorbing element 11, which is likewise preferably of circular ring-shaped design, albeit with different dimensions, is arranged on the side of the armature 4 which is remote from the stator 2. This corresponds to a variant c) of the invention.

A variant b) may also essentially also be created, in which only the shock-absorbing element 11 is present, i.e. without the shock-absorbing element 10.

The shock-absorbing element 11 may otherwise essentially have the same design as that described above for the shock-absorbing element 10. However—apart from their dimensioning—it is also possible for the two shock-absorbing elements 10, 11 to be designed differently, e.g. in terms of materials, material characteristics etc.

Starting with the illustration in FIG. 6, the following forces are in effect during the opening of the solenoid actuator (i.e. when the power source is switched off):

$${F}_{armature} ( s ) = - {F}_{spring} ( s ) + {F}_{damping , 2} ( \dot{s} ) .$$

The speed-dependent damping force F_{damping,2} (\dot{s}) due to the shock-absorbing element 11 ensures that the impact speed is restricted. It is (approximately) zero so long as the armature is not moving (\dot{s}=v=0).

FIG. 7 shows the same actuation device as that shown in FIG. 6, but in the open state of the solenoid actuator. During the closing procedure, the same applies as for FIG. 4:

During the closure of the solenoid actuator, i.e. when the magnetic coil 3 is energized, the following forces act on the armature 4 according to FIG. 7, s denoting the travel and s the speed:

$${F}_{armature} ( s , \dot{s} ) = {F}_{solenoid actuator} ( s ) - {F}_{spring} ( s ) - {F}_{damping , 1} ( \dot{s} ) .$$

The speed-dependent damping force F_{damping,1} (\dot{s}) due to the shock-absorbing element 10 in turn ensures that the impact speed is restricted. It is (approximately) zero so long as the armature is not moving (\dot{s}=v=0).

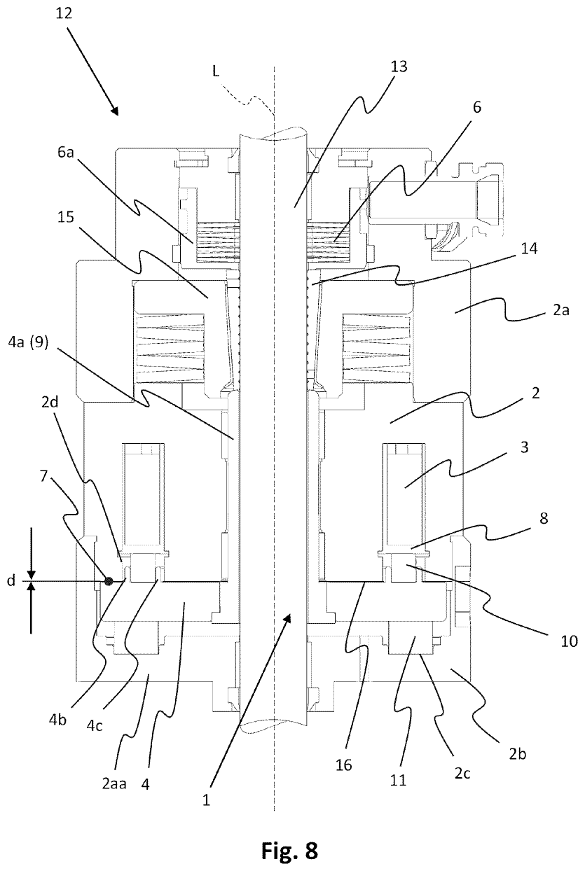

FIG. 8 shows an electromagnetically actuated braking or clamping device 12 according to the invention, which comprises an electromagnetic actuation device 1, as has essentially been described above. Identical reference signs here denote identical or at least identically acting elements.

As has already been described, the armature 4 in FIG. 8 extends through the stator 2 by means of a central armature extension 4a, which corresponds in terms of its mode of operation to the actuation element 9 in FIGS. 1 and 2. The bearing/housing part is designed in two parts, one part 2a (the first bearing/housing part)—as before—being arranged on the side of the arrangement which is remote from the armature 4, while the other part or a further bearing/housing part 2b is arranged on the armature side of the arrangement. Both parts 2a, 2b are firmly connected to the stator 2.

A rod 13 to be clamped is guided through the opening 1a (and the armature projection 4a), which is also formed in the further bearing/housing part 2b. Reference sign 6 in turn denotes the spring element in the form of a pressure spring, which is mounted in a cup-like spring seat 6a and is supported axially on one bearing/housing part 2a. Reference sign 14 denotes the clamping cage (already mentioned multiple times), which surrounds the rod 13 and has a conical external form. It is operatively connected to the armature 4 via the armature extension 4a thereof and, for the purpose of clamping the rod 13, cooperates with a clamping part 15 surrounding it, which has a complementary conical form on its inner side: if, owing to the spring force of the spring element 6 (when the magnetic coil 3 is de-energized), the clamping cage 14 moves axially into the clamping part 15, it is radially compressed and thus clamps the rod 13, whereas, when the magnetic coil 3 is energized, it is freed from clamping by the solenoid actuator (armature 4 and magnetic coil 3/stator 2) due to the action of the armature extension 4a, whereby the rod 13 is released again.

Reference signs 10 and 11 in turn denote shock-absorbing elements, as described in detail above. The are received in ring-shaped receptacles or holding structures, which are formed on the bearing/housing part 2b or the armature 4: reference sign 2c denotes a ring-shaped groove for the shock-absorbing element 11, while reference signs 4b, 4c denote two concentric ring-shaped projections on the armature 4, between which the shock-absorbing element 10 is arranged.

According to the illustration, the armature projection 4a forms an actuation element (c.f. reference sign 9 in FIGS. 1 and 2), which is designed to move the braking or clamping element (the clamping cage 14) from a first position, in which it brakes or clamps the rod 13, into a second position, in which it releases the rod 13, the relevant position being subject to an energization state of the magnetic coil 3 and therefore also to the width of the air gap between the armature 4 and stator 2. The said second position is shown in FIG. 8.

The spring element 6 is designed to bring the braking or clamping element (i.e. the clamping cage 14) into the first position, or to hold it in this position, when the magnetic coil 3 is de-energized, while the braking or clamping element (i.e. again the clamping cage 14) is moved into the second position by the actuation element (the armature extension 4a), in opposition to the effect of the spring element 6, when the magnetic coil 3 is energized, as shown.

Finally, the electromagnetically actuated braking or clamping device 12 or the electromagnetic actuation device 1 included therein has a thin damping film or spacer film (denoted by reference sign 16), which is preferably made of a laminated adhesive tape comprising a polyester nonwoven material with acrylate adhesive and which, via its thickness d of preferably approximately 0.2-0.3 mm, defines a minimal width of the air gap 7, to which reference has already been made.

The spacer film 16 is preferably designed to be self-adhesive and may optionally be mounted either on the armature 4, in a region radially inside and outside the projections 4b, 4c, or on the stator 2, radially inside and outside a ring-shaped depression 2d for receiving the magnetic coil 3. The spacer film 16 itself may also have shock-absorbing properties, preferably according to FIG. 3.

1. An electromagnetic actuation device (1) for a braking or clamping device (12), the electromagnetic actuation device comprising:
a stator (2) having an energizable magnetic coil (3);
an armature (4), which is movable relative to the stator (2);
a spring element (6), designed and arranged and mechanically operatively connected to the armature (4) such that, when the magnetic coil (3) is de-energized, an air gap (7) having a first width (B) is formed between the armature (4) and the stator (2), the spring element (6) having a first pretension, and, when the magnetic coil (3) is energized, a width (b) of the air gap (7) between the armature (4) and the stator (2) is reduced relative to the first width (B), the spring element having a second pretension, which is greater than the first pretension;
an actuation element (4a, 9), which is in operative communication with the armature (4) and is adapted to actuate the braking or clamping device (12) subject to a position of the armature (4);
at least one shock-absorbing element (10, 11) having a speed-dependent damping force characteristic, which is arranged between the armature (4) and stator (2);
at least one further shock-absorbing element (11) being arranged on a side of the armature (4) which is remote from the stator (2), between the armature (4) and a bearing/housing part (2b); and
the at least one shock-absorbing element (10) is arranged axially between the magnetic coil (3) and armature (4).

2. The electromagnetic actuation device (1) as claimed in claim 1, wherein the spring element (6) is arranged between the armature (4) and the stator (2) or between the armature (4) and a first bearing/housing part (2a) connected to the stator (2), wherein, the armature (4) extends through the stator (2) by an armature extension (4a) and is adapted to act directly or indirectly on the spring element (6) by the armature extension (4a).

3. The electromagnetic actuation device (1) as claimed in claim 1, wherein the at least one shock-absorbing element and the at least one further shock-absorbing element (10, 11) are made from a material which, in case of a mechanical action having an increasing active speed, generates an increasing counter-force opposing the action, wherein the counter-force at a speed of zero is substantially zero.

4. The electromagnetic actuation device (1) as claimed in claim 1, wherein the at least one shock-absorbing element and the at least one further shock-absorbing element (10, 11) are made from a viscoelastic plastic material.

5. The electromagnetic actuation device (1) as claimed in claim 1, wherein the at least one shock-absorbing element and the at least one further shock-absorbing element (10, 11) are made from a polyurethane material.

6. The electromagnetic actuation device (1) as claimed in claim 1, wherein the at least one shock-absorbing element and the at least one further shock-absorbing element (10, 11) are made from a same material or materials with the same damping properties on both sides of the armature (4).

7. The electromagnetic actuation device (1) as claimed in claim 1, wherein the at least one shock-absorbing element and the at least one further shock-absorbing element (10, 11) are made from different materials or materials with different damping properties on both sides of the armature (4).

8. The electromagnetic actuation device (1) as claimed in claim 1, further comprising a spacer film (16) with a film thickness (d) arranged between the armature (4) and stator (2), in a region separated from the at least one shock-absorbing element (10), the said minimal width being defined by the film thickness (d).

9. The electromagnetic actuation device (1) as claimed in claim 8, wherein the spacer film (16) is applied to the armature (4) or to the stator (2).

10. The electromagnetic actuation device (1) as claimed in claim 9, wherein at least the armature (4) and the stator (2) are designed to be rotationally symmetrical and each have a central opening (1a) through which a rod (13) to be braked or clamped is adapted to be or is guided, and at least one of the at least one shock-absorbing element (10) or the at least one further shock-absorbing element (11) is ring-shaped and is arranged concentrically to the openings (1a).

11. The electromagnetic actuation device (1) as claimed in claim 10, wherein the spacer film (16) is of ring-shaped design and is arranged at least one of concentrically around the at least one shock-absorbing element (10) or concentrically to the openings (1a), radially within the shock-absorbing element (10).

12. The electromagnetic actuation device (1) as claimed in claim 1, wherein the armature (4) or the stator (2) has a holding structure (4b, 4c) for the at least one shock-absorbing element (10).

13. The electromagnetic actuation device (1) as claimed in claim 1, wherein the bearing/housing part (2b) has a holding structure (2c) for the at least one further shock-absorbing element (11); and the bearing/housing part (2b) is adapted to be rotationally symmetrical and has a central opening (1a) through which a rod (13) to be braked or clamped is adapted to be or is guided.

14. The electromagnetic actuation device (1) as claimed in claim 1, wherein the at least one shock-absorbing element and the at least one further shock-absorbing element (10, 11) have a linear or non-linear damping force characteristic subject to the speed.

15. An electromagnetically actuated braking or clamping device (12), comprising:
the electromagnetic actuation device (1) as claimed in claim 1;
at least one braking or clamping element (14), which is designed to act on an object (13) to be braked or clamped;
the actuation element (4a) is adapted to move the braking or clamping element (14) from a first position, in which it brakes or clamps the object (13), into a second position, in which it releases the object (13), or vice versa, with the position being subject to an energization state of the magnetic coil;
wherein the spring element (6) is adapted to bring the braking or clamping element (14) into the first position, or to hold it in the first position, when the magnetic coil (3) is de-energized, while the braking or clamping element (14) is moved into the second position by the actuation element (4a) when the magnetic coil (3) is energized.

16. An electromagnetically actuated braking or clamping device (12), comprising:
an electromagnetic actuation device (1) for a braking or clamping device (12), the electromagnetic actuation device including:
a stator (2) having an energizable magnetic coil (3),
an armature (4), which is movable relative to the stator (2),
a spring element (6), designed and arranged and mechanically operatively connected to the armature (4) such that, when the magnetic coil (3) is de-energized, an air gap (7) having a first width (B) is formed between the armature (4) and the stator (2), the spring element (6) having a first pretension, and, when the magnetic coil (3) is energized, a width (b) of the air gap (7) between the armature (4) and the stator (2) is reduced relative to the first width (B), the spring element having a second pretension, which is greater than the first pretension,
an actuation element (4a, 9), which is in operative communication with the armature (4) and is adapted to actuate the braking or clamping device (12) subject to a position of the armature (4),
at least one shock-absorbing element (10, 11) having a speed-dependent damping force characteristic, which is arranged between the armature (4) and stator (2), and
at least one further shock-absorbing element (11) being arranged on a side of the armature (4) which is remote from the stator (2), between the armature (4) and a bearing/housing part (2b);
at least one braking or clamping element (14), which is designed as a clamping cage to act on an object (13), in the form of a rod, to be braked or clamped;
the actuation element (4a) is adapted to move the braking or clamping element (14) from a first position, in which it brakes or clamps the object (13), into a second position, in which it releases the object (13), or vice versa, the position being subject to an energization state of the magnetic coil (3); and
the spring element (6) is adapted to bring the braking or clamping element (14) into the first position, or to hold it in the first position, when the magnetic coil (3) is de-energized, while the braking or clamping element (14) is moved into the second position by the actuation element (4a) when the magnetic coil (3) is energized.
